(19) United States
(12) Patent Application Publication
(10) Pub. No.: US 2016/0253609 A1
(43) Pub. Date: Sep. 1, 2016

(54) Information Processing System and Information Processing Method

(71) Applicant: HITACHI, LTD., Chiyoda-ku Tokyo (JP)

(72) Inventors: Nobuo SATO, Tokyo (JP); Kazuo YANO, Tokyo (JP); Tomoaki AKITOMI, Tokyo (JP); Fumiya KUDO, Tokyo (JP)

(73) Assignee: Hitachi, Ltd., Tokyo (JP)

(21) Appl. No.: 14/766,260

(22) PCT Filed: Apr. 14, 2014
(86) PCT No.: PCT/JP2014/060564

§ 371 Date: Aug. 6, 2015

(51) Int. Cl. G06Q 10/06

(52) U.S. Cl. CPC G06Q 10/0637

(57) ABSTRACT

For providing an information processing system which enables easier automatic extraction of a more suitable object for which a measure is to be taken, the information processing system for extracting the object for which the measure is taken is configured to include: a reception. unit (GSO5) which receives first data (GSC11) related to business of an enterprise and second data (GSC12) that is related to the business of the enterprise and has granularity equal to or finer than the granularity of the first data; an index generation unit (GSO2) which generates, from the first data, a plurality of descriptive indices matching the granularity of the second data; and an extraction unit (GSO1) which extracts from the descriptive indices, the object for which the measure is to be taken.

### TECHNICAL FIELD

The present invention relates to an information processing system and an information processing method. More specifically, the present invention relates to an information processing system and an information processing method for extracting an object for which a measure is taken.

### BACKGROUND ART

As a large amount of data related to business management is accumulated in association with development of information and communication technology, a technique for utilizing the data is demanded which enables a person to easily derive a measure having effects in management even if the person is not an expert of analysis. Conventionally, a technique in which an executive or analyst forms a limited hypothesis based on the experiences or intuition thereof and gathers and analyzes data in order to support the hypothesis, or a technique in which the methodology of a skilled analyst is used as a template and is developed is commonly used, for example. In those conventional techniques, setting the hypothesis depends on human abilities and therefore the range of the derived measure is limited.

In shop management, for example, a technique is known in which information on the number of purchases and the unit price of each item from a POS system, the buying behaviors of customers, information on the service behaviors of workers, and the like are analyzed together (Patent Literature 1). In this analyzing method, the number of purchases as a target index and a data set of descriptive indices such as behavior information used for increasing the unit price of an item are based on the hypothesis preset by an analyst.

### CITATION LIST

### Patent Literature

Patent Literature 1: WO2005/111880

### SUMMARY OF INVENTION

### Technical Problem

Since the descriptive index in Patent Literature 1 is based on the hypothesis preset by the analyst, it is difficult to form a hypothesis beyond the ability of the analyst. For example, a measure in which coupons are distributed to particular customers in a shop is considered. In this case, a decision-maker such as a manager or a shop manager usually corresponds to the analyst. In the method described in Patent Literature 1, the distribution of the coupons has to rely on the experiences or intuition of the decision-maker, and it has been difficult to take an effective measure for raising a target such as a profit.

On the other hand, in current shops, business data such as POS data is accumulated. Therefore, it can be considered to perform statistical analysis on the basis of the business data to decide objects of more efficient distribution. However, in this case, there is a problem that since the business data is a large amount of data or a so-called big data, the amount of calculation is also large in association with the data amount. Thus, it is necessary to adopt a limitation on the statistical analysis to suppress the amount of calculation.

Moreover, even if a group of customers highly correlated with a target such as a profit (i.e., a group of customers for which distribution of coupons is effective) is derived by the statistical analysis, this group of customers may be a complicated function having a number of parameters. In this case, the decision-maker has to interpret the meaning of that group of customers before taking a specific measure, which is impractical. Furthermore, when the group of customers is the one for which the decision-maker cannot take a measure practically, this makes no sense in real business.

As described above, stastical analysis in real business must output a solution that enables the decision-maker to take a measure more easily. The decision-maker usually has a policy of the measure to some extent. In the example of distribution of coupons, for example, the policy such as “shops where distribution is performed” and “an item as an object of the coupon” is decided and thereafter consideration which specific customers are suitable for distribution is performed. Thus, statistical analysis in real business has to be performed to satisfy this policy, that is, to automatically extract customers more suitable as objects for which the measure is to be taken.

The above description is made referring to the example in which coupons are distributed to customers. This is the same in other business areas such as project management and logistics field.

In view of the above, it is an object of the present invention to provide an information processing system or an information processing method which enables easier extraction of an object for which a measure is to be taken.

### Solution to Problem

A typical example of a solution of the problem by the present invention is an information processing system for extracting an object for which a measure is to be taken, and includes a reception unit configured to receive first data related to business of an enterprise and second data that is related to the business of the enterprise and has granularity equal to or finer than the granularity of the first data; an index generation unit configured to generate, from the first data, a plurality of descriptive indices matching the granularity of the second data; and an extraction unit configured to extract the object for which the measure is to be taken from the plurality of descriptive indices.

Moreover, an information processing method for extracting an object for which a measure is to be taken, includes: a first step of receiving first data related to business of an enterprise and second data that is related to the business of the enterprise and has granularity equal to or finer than the granularity of the first data; a second step of generating, from the first data, a plurality of descriptive indices matching the granularity of the second data; and a third step of extracting the object for which the measure is to be taken from the plurality of descriptive indices.

### Advantageous Effects of Invention

According to the present invention, it is possible to more easily extract a suitable object for which a measure is to be taken.

### BRIEF DESCRIPTION OF DRAWINGS

FIG. 1 is a schematic diagram of an information processing system according to a first embodiment.

FIG. 2 is a flowchart of an information processing method according to the first embodiment.

FIG. 3 is a sequence diagram of the information processing method according to the first embodiment.

FIG. 4 is a schematic diagram of an index generation process according to the first embodiment.

FIG. 5 is a schematic diagram of a micro data table according to the first embodiment.

FIG. 6 is a schematic diagram of a macro data table according to the first embodiment.

FIG. 7 is a schematic diagram of a correlation table according to the first embodiment.

FIG. 8 is a schematic diagram of an evaluation function table according to the first embodiment.

FIG. 9 is a schematic diagram of an object customer extraction table according to the first embodiment.

FIG. 10 is a schematic diagram of a micro data table and a macro data table according to a second embodiment.

FIG. 11 is a schematic diagram of a micro data table and a macro data table according to a third embodiment.

### DESCRIPTION OF EMBODIMENTS

### First Embodiment

In this embodiment, as an exemplary information processing system for extracting an object for which a measure is to be taken, an exemplary information processing system is described which finds out, by automatic control, which customer an item is offered to for increasing the sales of a store.

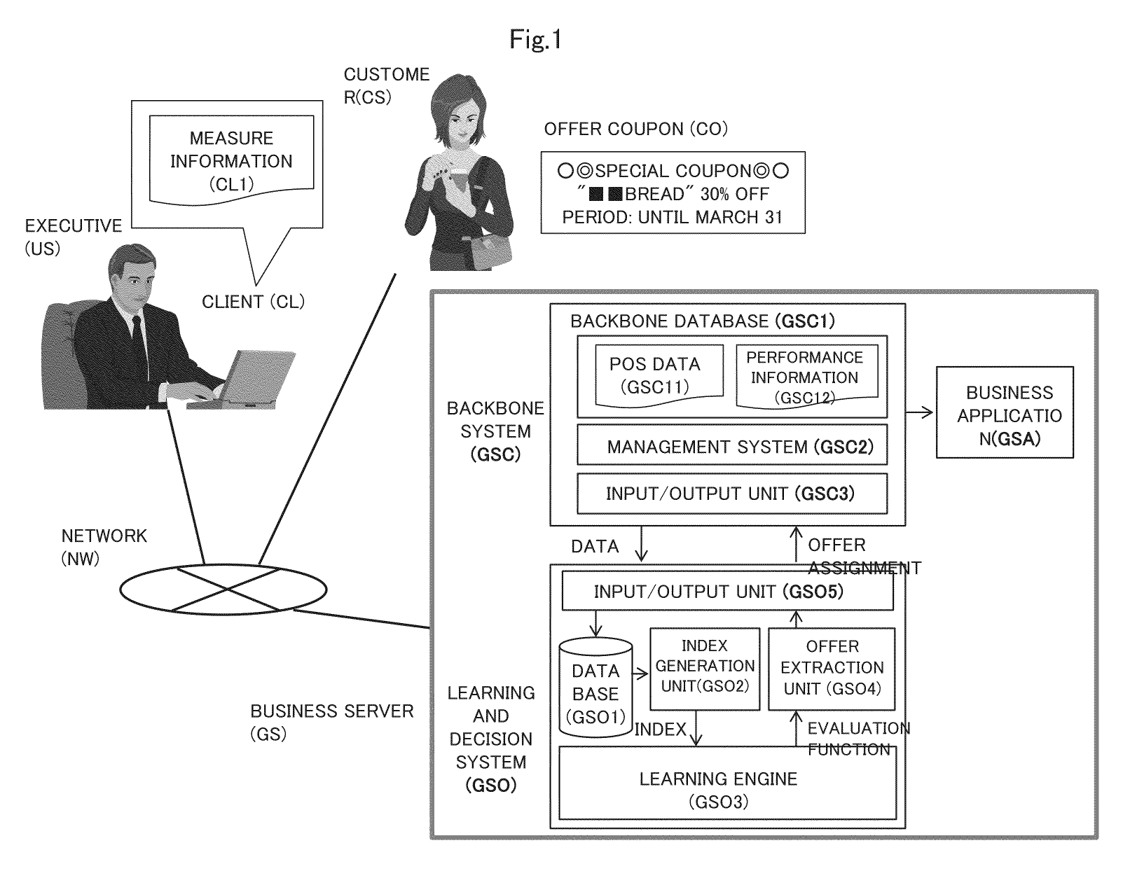

FIG. 1 is an exemplary structure diagram of the information processing system of this embodiment. An executive (US) is a decision-maker who tries to provide an offer coupon (CO) to a customer (CS). The executive (US) referred to herein is not always limited to a real executive, but can be a person having the authority of decision in the shop, such as a manager or a shop manager.

A client (CL) is connected to a business server (GS) and is operated by the executive (US). A network (NW) connects the client (CL), the business server (GS), and the customer (CS) to one another, and receives an input of measure information (CL1) from the executive (US) in measure determination (Z00) to be described later.

The business server (GS) is an information processing system which, for increasing the sales of items in the shop in this embodiment, automatically extracts customers as objects and recommends an item to the customers as the objects, and includes a group of the following systems.

A backbone system (GSC) is a system required for execution of business and includes a backbone database (GSC1), a management system (GSC2), and an input/output unit (GSC3). The backbone database (GSC1) stores various kinds of data required for the backbone system, such as POS data (GSC11) and performance information (GSC12). The POS data (GSC11) usually has a format formed by a plurality of purchase results for each receipt ID (for each unit of payment), while the performance information (GSC12) usually has a format of “sales in a certain period in a certain shop” and is stored with granularity equal to or finer than that of the POS data (GSC11). Alternatively, the granularity of the performance information (GSC12) can be interpreted as being different from that of the POS data (GSC11). The granularity referred to here is a range in each unit of data, within which information is gathered and which can be handled as one numerical value.

The performance information (GSC12) can be quantitatively evaluated in terms of money. This is for quantitative evaluation of a measure later. The management system (GSC22) is a system which performs general management processes such as a process for managing customers, a process for managing a shop operation, a process for managing items, and a process for managing purchase records.

A learning and decision system (GSO) is a system which uses data in the backbone database (GSC1) to decide a condition suitable for an offer. Although FIG. 1 shows that the learning and decision system is stored in the same server as the backbone system (GSC), the learning and decision system may be provided in a different server to be connected to the backbone system (GSC) online, for example.

A database (GSO1) stores data used by the learning and decision system (GSO). An index generation unit (GSO2) uses the data from the database (GSO1) to generate an index. A learning engine (GSO3) creates an evaluation function required for extraction of customers as objects, from the index generated by the index generation unit. (GSO2). An offer extraction unit (GSO4) obtains, from the evaluation function created by the learning engine (GSO3), the customers as the objects. An input/output unit (GSO5) performs a process for receiving data from the backbone system (GSC) and a process for transmitting object customer information to the backbone system (GSC) and assigning an offer.

A business application (GSA) is an application which distributes coupons for recommending an item to the customer (CS) included in the customers as the objects output from the offer extraction unit (GSO4).

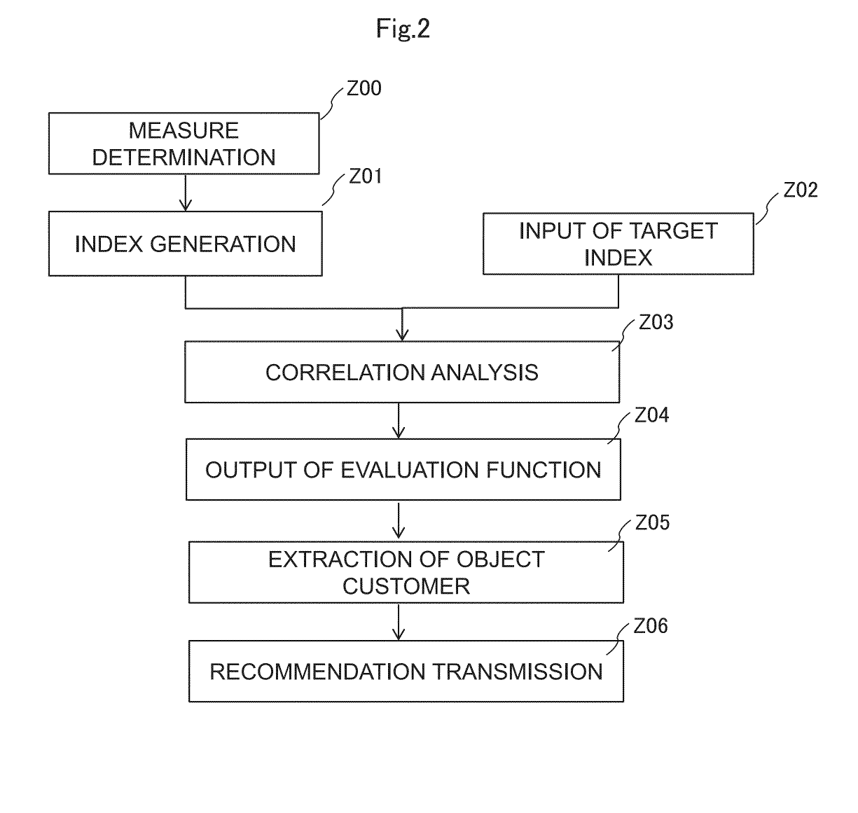

FIG. 2 shows a flow until the executive (US) sends a coupon to the customer (CS) as the object.

In measure determination (Z00), a measure and a condition thereof are determined. In a case where a measure in which coupons are distributed to particular customers (CS) for accelerating purchase is taken, for example, (1) the outline of the measure that “coupons are distributed” may be only determined and other conditions may be automatically generated, or (2) conditions may be applied to attributes of “area” and “item”, e.g., “bread coupons are distributed in shops in Kanto area” and it may be automatically generated which category is suitable for another attribute. In the following example, the description is made assuming that the position of (2) is taken.

As specific examples of attributes, gender, age, and the purchase time period are used in this emboddment, for example. However, another attribute can also be used. Moreover, categories into which customers are categorized are defined by further dividing each attribute. Exemplary categories corresponding to the respective attributes are men and women for gender, teens, 20s, . . . , for age, and between 7 and 8 o'clock, between 8 and 9 o'clock, between 9 and 10 o'clock, . . . , for the periods of the customers. Other categories may be used.

In the measure determination (Z00), the measure is not necessarily determined every time, but the measure once defined and the condition associated therewith may be used a plurality of times.

Index generation (Z01) is calculation in the index generation unit (GSO2) and is specifically a process for automatically generating a plurality of descriptive indices matching the granularity of measure determined in the measure determination (Z00) based on the data in the management system (GSC22) or the database (GSO1). It is assumed here that, in the index generation unit (GSO2), input data is a micro data table (GSO11) and output data is the micro data table (GSO12). Those two tables have different granularities.

The micro data table (GSO11) is desirably data that can be classified into categories. When the micro data table is not such data, it is converted by the index. generation unit (GSO2) as appropriate. Then, indices are automatically generated in the index generation unit (GSO2) by a category combining process, and the result is stored in the macro data table (GSO12).

Input of target index (Z02) is a process for receiving an input of an index to be improved by an action (target index) from the executive (US). The target index is not necessarily determined every time. The target index once defined may be used a plurality of times.

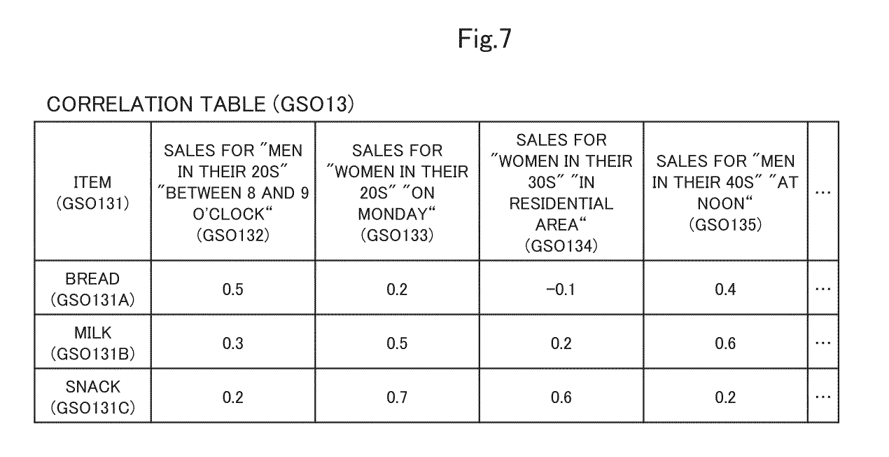

Correlation analysis (Z03) is a process performed in the learning engine (GSO3), and is a process which performs correlation analysis using the descriptive indices generated by the index generation (Z01) and the target index input in the input of target index (Z02). The result of the process is stored in a correlation table (GS013) in FIG. 7.

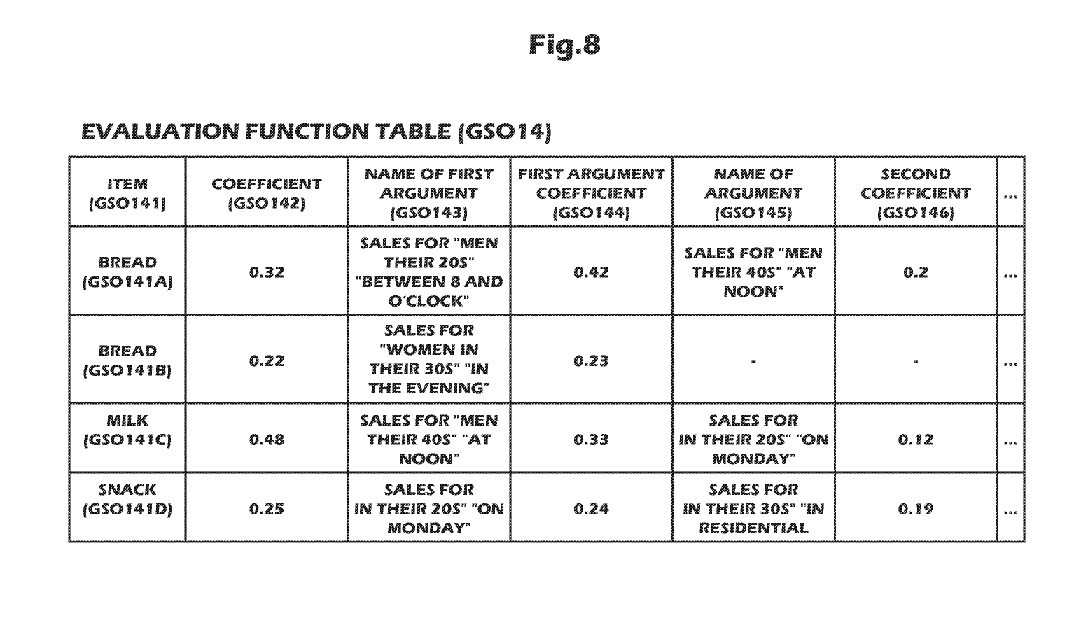

Output of evaluation function (Z04) is a process performed in the learning engine (GS03), and is a process for obtaining an evaluation function for the measure by usino the correlation table (GS013) in FIG. 7. The result is stored in an evaluation function table (SGO14) in FIG. 8.

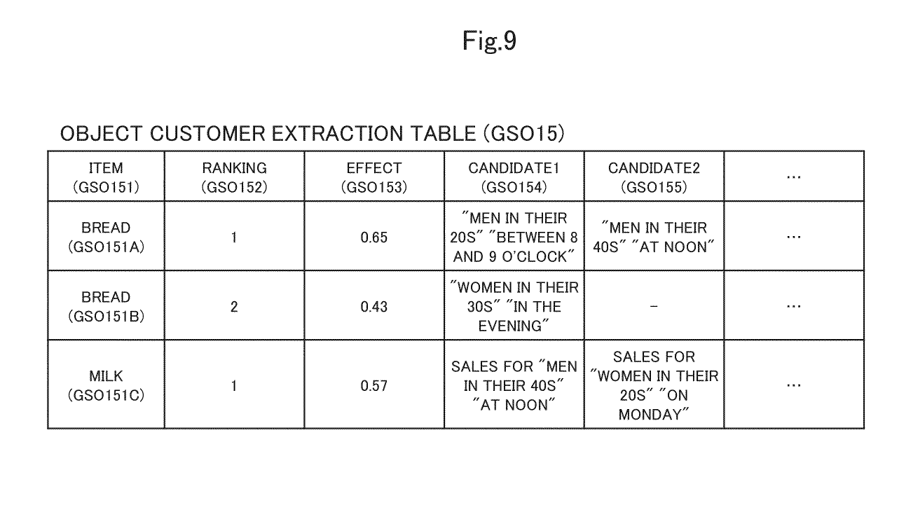

Extraction of object customer (Z05) is a process performed in the offer extraction unit (GSO4), and is a process which uses the data contained in the evaluation function table (GSO14) in FIG. 7 and the management system (GSC22) to extract the customers as the objects. The extracted customers as the objects are stored in an object customer extraction table (GSO15) in FIG. 9.

Recommendation transmission (Z06) is a process performed in the business application (GSA), and is a process which specifies customers by the object customer extraction table (GSO15) in FIG. 9 and sends the customers coupons.

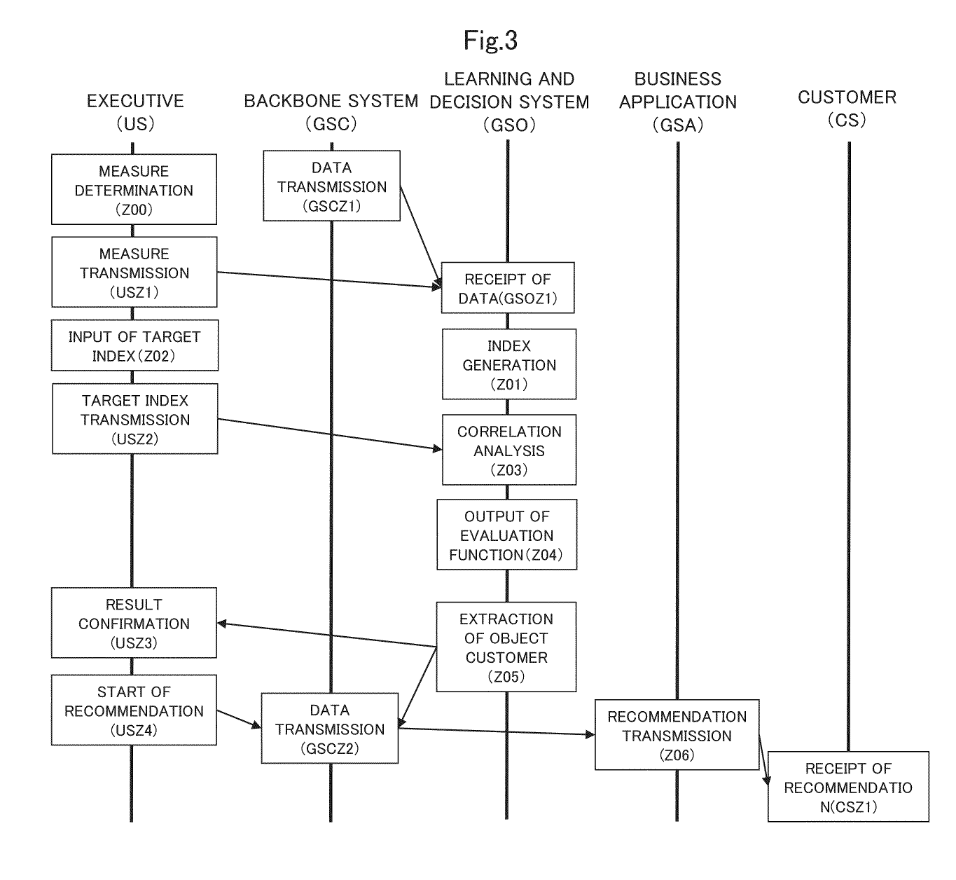

FIG. 3 is a sequence diagram showing the relationship among the executive (US), the backbone system (GSC), the learning and decision system (GSO), the business application (GSA), and the customer (CS).

POS data (GSC11) and performance information (GSC12) are accumulated in the backbone database (GSCI) of the backbone system (GSC), and are transmitted to the learning and decision system (GSO) in data transmission (GSCZ1).

In parallel with this, when considering distribution of coupons to customers as objects, the executive (US) inputs measure information (CL1) to the client (CL) in the measure determination (Z00). This measure information (CL1) is transmitted from the client (CL) to the learning and decision system (GSO) in measure transmission (USZ1). In the input, of target index (Z02), the executive (US) inputs the target index that is an index to be improved by the measure, to the client (CL). The target index is transmitted from the client (CL) to the learning and decision system (GSO) in target index transmission (USZ2).

Although the input of target index (Z02) is performed after the measure determination (Z00) for convenience, the order is not limited. They may be performed in the reverse order, or may be performed simultaneously.

The learning and decision system (GSO) receives the data transmitted in the data transmission (GSCZ1) and the measure transmission (USZ1), in receipt of data (GSOZ1). In the index generation (Z01), based on the thus received data, automatic generation of a descriptive index are performed. At this time, in a case where the POS data (GSC11) and the performance information (GSC12) do not have the above-described desired formats, the data formats are changed as appropriate.

Then, in the correlation analysis (Z03), correlation analysis using the target index and the descriptive indices generated by the index generation (Z01) is performed.

Subsequently, in the output of evaluation function (Z04), evaluation of the descriptive index selected by the correlation analysis (Z03) is performed, and an evaluation function is output.

In the extraction of abler: customer (Z05), based on the evaluation result in the output of evaluation function. (Z04), customers as the objects and the prorities thereof are obtained. The result is transmitted to the executive (US) and the backbone system (GSC).

In result confirmation (USZ3), the executive (US) judges whether or not the result of the extraction of object customer (Z05) is appropriate for the measure to be taken this time. When the measure is judged to be appropriate, the executive (US) inputs to the client (CL) a trigger for activating a program which sends coupons to the customers as the objects, in start of recommendation (USZ4).

In response to the start of recommendation (USZ4) as its trigger, the management system (GSC2) of the backbone system (GSC) transmits customer information required for sending the coupons such as mail addresses to the business application (GSA) in data transmission (GSCZ2).

The business application (GSA) acquires the aforementioned customer information by the data transmission (GSCZ2) from the management system (GSC2), and sends the coupons to the customers (CS) as the objects in the recommendation transmission (Z06).

The customer (CS) can obtain the coupon by receipt of recommendation (CSZ1).

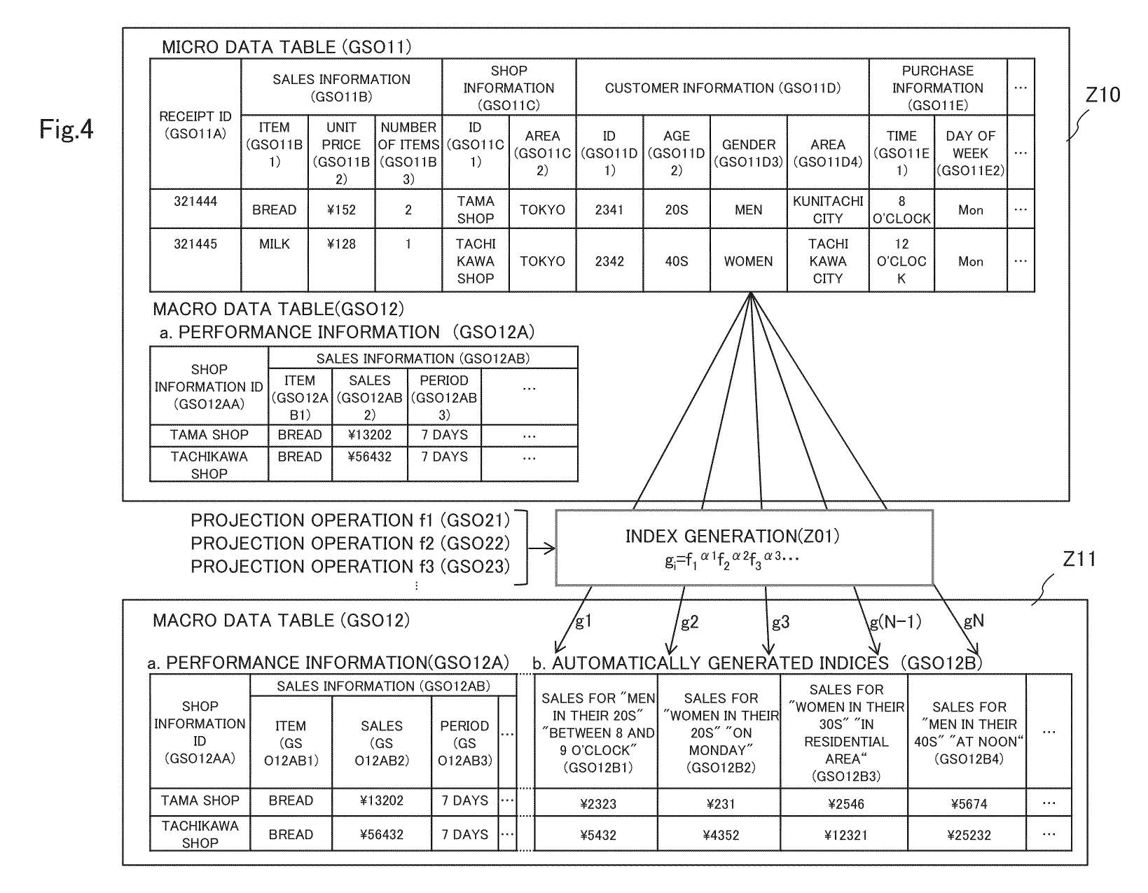

FIG. 4 schematically shows a stage in which indices are generated in the index generation unit (GSO2) of the learning and decision system (GSO). Original data is denoted with Z10 and data generated by the index generation unit (GSO2) is shown as automatically generated indices (GS012B) of Z11.

The index generation unit (GSO2) performs a process for generating descriptive indices using various types of data shown in Z10 as input data. Projection operations f1 (GSO21), f2 (GSO22), f3 (GSO23), . . . used in the generation process are defined in advance in the index generation unit (GSO2) using data that can be classified into categories contained in the micro data table (GSO11). The number of the projection operations can be specified to a given number.

For example, “distribution of bread coupons in shops in Kanto area” has been determined in the measure determination (Z00) in this embodiment. Therefore, from various units of data contained in the micro data table (GSO11), data in which the item (GSO11B1) of the sales information (GSO11B) is bread and the ID (GSO11C1) of the shop information (GSO11C) is a shop in Kanto area is extracted.

It is assumed that the projection operation f1 (GSO21) is an operation for automatically generating an index that is the sales for “men in their 20s ” “between 8 and 9o'clock” (GSO12B1), for example. Then, the projection operation f1 ((GSO21) is specifically an operation for adding up the unit price (GS011B2) in data of which the age (GSO11D2) and the gender (GSO11D3) of the customer information (GSO11D) are 20's and men, respectively, and the time (GSO11E1) of the purchase information (GS11E) is between 8 and 9 o'clock, for example, (another operation may be performed as appropriate), so that “2323 yen” to be input to the macro data table (GSO12) is obtained. For other indices, similar projection operations are performed, thereby the macro data table (GSO12) is completed.

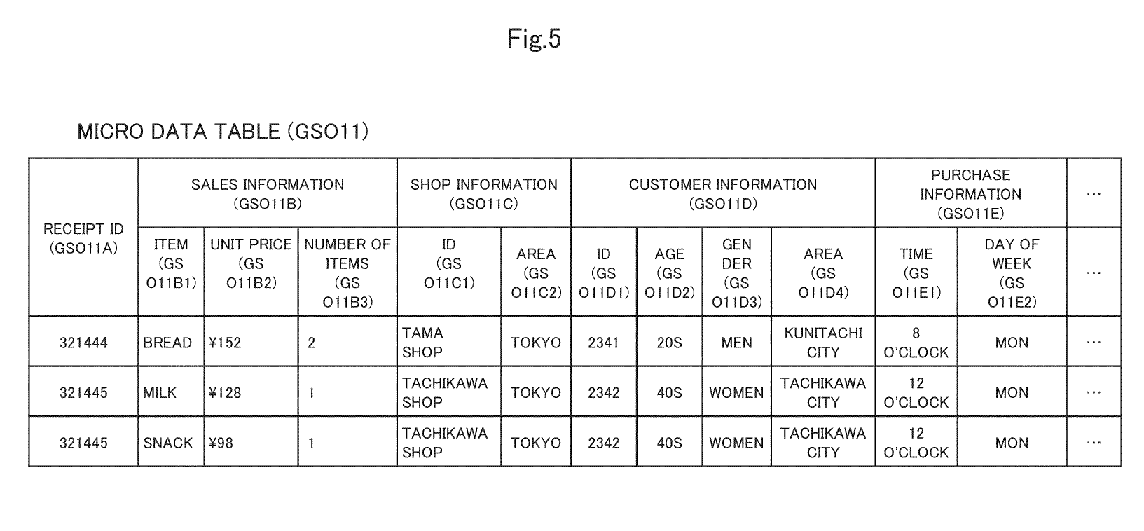

FIG. 5 shows the micro data table (GSO11) stored in the database (GSO1) for being used in the learning and decision system (GSO), based on the POS data (GSC11) stored in the backbone database (GSC1). The storage unit of data in the micro data table (GSO11) is desirably the smallest possible granularity. In FIG. 5, the data is stored for each item (GSO11B1) of a certain receipt ID (GSOO11A).

The data in the micro data table (GS011) desirably has a format in which the data is classified into categories. Otherwise, modification of the data is performed as appropriate in the index generation unit (GSO2). Moreover, the data may be generated based on data that is not used in the management system (GSC2), such as sensor data. Furthermore, when the granularities of the assioned data are different, the granularities may be made the same by the index generation unit (GSO2).

The receipt ID (GSO11A) is the ID of a receipt corresponding to one unit of purchase. Since data is stored for each item (GSO11B1) in FIG. 5, the receipt ID (GSO11A) can appear a plurality of times.

Sales information (GSO11B) is information indicating the sales. An item (GSO11B1) indicates the name of the purchased item, a unit price (GSO11B2) indicates the unit price of the purchased item, and the number of items (GSO11B3) indicates the number of the items purchased.

Shop information (GSO11C) is information indicating the shop in which the purchase has been made. An ID (GSO11C1) shows the number for identifying the shop, and an area (GSO11C2) shows the area where the shoo is located.

Customer information (GSO11D) is information showing the customer of the purchase. An ID (GSO11D1) shows the number for identifying the customer, an age (GS011D2) shows the age of the customer, a gender (GSO11D3) shows the gender of the customer, and an area (GSO11D4) shows the area of the house of the customer.

Purchase information (GSO11E) is information showing the condition of the purchase. Time (GSO11E1) shows she time of purchase, and day of the week (GS011E2) shows the day of the week of the purchase.

Other than the above, it suffices that data can be used as input data of the learning and decision system (GSO). Therefore, data other than the above, can be added if the data is effective for analysis.

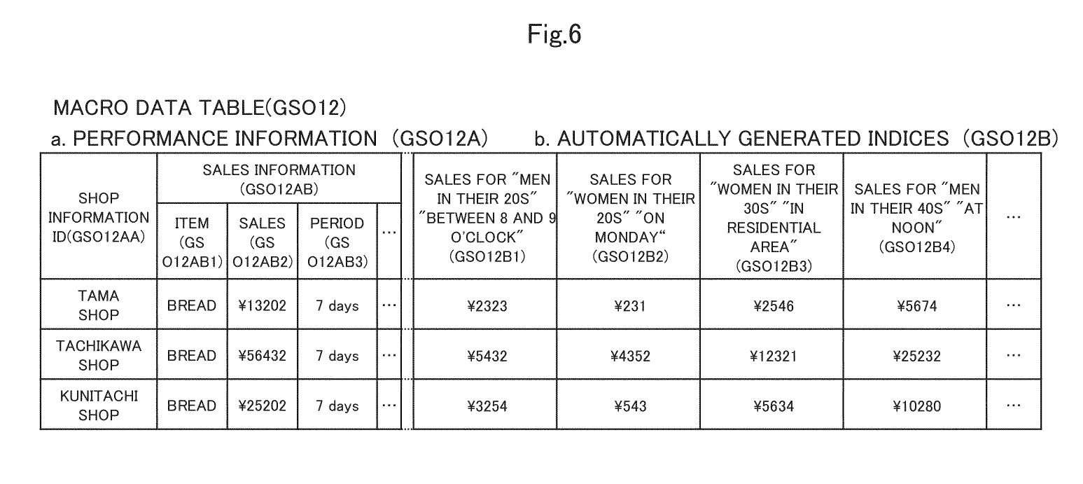

FIG. 6 shows the macro data table (GS012) stored in the database (GSO1) for being used by the learning and decision system (GSO), based on the POS data (GSC11) and the performance information (GSC12) stored in the backbone database (GSC1). The macro data table (GSO12) is stored in a format corresponding to the measure and the condition of the measure that have been determined in the measure determination (Z00), and is a data format in which the shop information ID (GSO12AA) shows a shop in Kanto area and an item (GSO12AB1) shows bread in FIG. 6. When the item is not limited in the measure determination (Z00), a table corresponding to the macro data table in FIG. 6 is generated for each of items other than bread such as milk.

Performance information (GSO12A) is generated from the POS data (GSC11) and/or the performance information (GSC12) stored in the backbone database (GSC1) and contains the following information.

A shop information ID (GSO12AA) is information indicating the unique number of a shop.

Sales information (GSO12AB) is information indicating the sales of the item. An item (GSO12AB1) shows the name of the item, sales (GSO12AB2) shows the sales amount, and a period (GSO12AB3) shows a data gathering period. In FIG. 6, for example, for Tama shop as the shop information ID (GSO12AA), 13202 yen as the sales (GSO12AB2) for bread as the item (GSO12AB1) and 7 days as the period. (GS012AB3) are shown.

In automatically generated indices (GS012B), descriptive indices automatically generated by the index generation unit. (G502) from the micro data table (GS011) by means of the projection operation are stored. The granularity of toe automatically generated indices (GSO12B) matches the performance information (GSO12A).

Here, as exemplary descriptive indices generated by the index generation unit (GSO2), the sales for “men in their 20's” “between 8 and 9 o'clock” (GSO12B1), the sales for “women in their 20's” “on Monday” (GSO12B2), the sales for “women in their 30's” “in residential area” (GSO12B3), and the sales for “men in their 40s” “at noon” (GSO12B4) are listed.

In each column, the sales amounts are stored in accordance with the corresponding condition. The sales for “men in their 20's” “between 8 and 9 o'clock] (GSO12B1) is 2323 yen, the sales for “women in their 20 ”on Monday” (GSO12B2) is 231 yen, the sales for “women in their 30s” “in residential area” (GSO12B3) is 2546 yen, and the sales for “men in their 40s” “at noon” (GSO12B4) is 5674 yen. Of course, a descriptive index other than those can be added.

In the example of FIG. 6, the macro data table (GSO12) is generated with a shop as the granularity. However, other granularity corresponding to the condition of the measure, e.g., a city, a town, and a village, can be used. Although the macro data table (GSO12) is generated on the item-by-item basis in the example of FIG. 6, it may be generated for a unit suitable for the measure such as food. Moreover, in the example of FIG. 6, the sales amount is used. However, in a case where a process such as normalization is additionally performed, an index used for that process can be added to the sales information (GSO12AB). Furthermore, although the sales mount is used in the example of FIG. 6, an index used in that process, e.g., the number of the sold items, can be added to the sales information (GSO12AB) for employing a target index suitable for the measure.

As described above, the information processing system. (GSO) extracting an object for which a measure is to be taken, according to this embodiment, is characteristic in having the reception unit (GSO5) which receives the first data (GSC11) related to business of an enterprise and the second data (GSC12) that is related to the business or the enterprise and has granularity equal to or finer than that of the first data; the index generation unit (GSO2) which generates a plurality of descriptive indices (GSO12B1 to GSO12R4) matching the granularity of the second data from the first data; and the extraction unit. (GSO4) which extracts, from the plurality of descriptive indices, the object for which the measure is to be taken.

Moreover, the information processing method (GSO) for extracting the object for which the measure is to be taken, according to this embodiment, is characteristic in having the first step of receiving the first data (GSC11) related to business of an enterprise and the second data (GSC12) that is related to the business of the enterprise and has granularity equal to or finer than that of the first data; the second step generating a plurality of descriptive indices matching the granularity of the second data from the first data and the third step of extracting, from the plurality of descriptive indices (GSO12B1 to GSO12B4), the object for which the measure is to be taken.

With those structures, the information processing system and the information processing method according to this embodiment can automatically extract the most suitable object for the measure in form of the descriptive index from the correlation table (GSO13). Consequently, extraction of the object beyond the analytical ability can be performed more easily without depending on the experiences and intuition of the decision-maker.

FIG. 7 shows the correlation table (GSLO13) in which the results of the process by the learning engine (GSO3) using the macro data table (GSO12) is stored. The correlation table (GSO13) is contained in the database (GSO1). The correlation table (GSO13) uses the same unit as that of the data stored in the macro data table (GSO12), and is stored on the item-by-item basis in FIG. 7.

An item (GSO131) indicates the item used in the correlation. For bread (GSO131A), the descriptive indices for which correlation in relation to the bread is obtained are stored. The stored descriptive indices are the same as those in the example of FIG. 6, and are the sales for “men in their 20s” “between 8 and 9o'clock” (GSO132), the sales for “women in their 20s” “on Monday” (GSO133), the sales for “women in their 30s” “in residential area” (GSO134), and the sales for “men in their 40s” “at noon” (GSO135).

As the sales of the bread (GSO131A) for “men in their 20s” “between 8 and 9 0'clock” (GS0132), the correlation result of the sales (GSO12AB2) and the sales for “men in their 20s” “between 8 and 9 o'clock” (GSO12B1) in FIG. 6, i.e., 0.5 is stored.

As the sales of the bread (GSO131A) for “women in their 20s” “on Monday” (GSO133) , the correlation result of the sales (GSO12AB2) and the sales for “women in their 20s” “on Monday” (GSO12B2) in FIG. 6, i.e., 0.2 is stored.

In this manner, the obtained result of the correlation in the macro data table (GSO12) in FIG. 6 is stored in the correlation table (GSO13).

Although the unit is an item in the example of FIG. 7, the unit can be changed to another unit suitable for the measure such as food. Moreover, in the example of FIG. 7, correlation values are stored in cells. However, those can be changed to other values which enable an evaluation function to be obtained. Furthermore, the update interval of the evaluation function in the learning engine (GSO3) is not specifically limited. For example, the evaluation. function may be updated every week. The update interval can be changed to another interval suitable for the measure.

From this correlation table (GSO13), it is found that the sales for “men in their 20s” “between 8 and 9 o'clock” (GSO132) has the highest correlation with the sales of the bread (GSO131A) and distribution of bread coupons to men in their 20s who are in a shop between 8 and 9 'clock is the best. Similarly, for milk coupons, it is found that distribution to men in their 40s who are in a shop at noon is the best. This descriptive index is formed by a combination of the categories in the micro data table (GSO11). Therefore, it is easy to interpret the meaning of the descrptive index and to reflect the interpretation to the measure. Moreover, since convenience stores and the like currently employ a system which inputs information such as “male teenagers” or “women in their 20s”, as additional, information thereto at the time of payment, the present invention has high affinity with such an existing system.

From the correlation table (GSO13) in FIG. 7, the descriptive index extracted for each item. (GSO131) is one. However, in the real business, an increase in the candidates to which coupons are to be distributed is desired in some cases. Tables for extracting a plurality of candidates in those cases are an evaluation function table (GSO14) in FIG. 8 and an object customer extraction table (GSO15) in FIG. 9.

The evaluation function table (GSO14) is a table storing an evaluation function processed by the learning engine (GSO3) by using the correlation table (GSO13), and is contained in the database (GSO1). More specifically, the data stored in the correlation table (GSO13) is subjected to multiple regression analysis, so that an evaluation function for each item is obtained. A technique other than multiple regression analysis can be used as long as it provides the evaluation function. If necessary, other data such as the data in the micro data table (GSO11) or the macro data table. MSO12) can be used.

Items (GSO141) are stored as records for each item. The evaluation function for the item MSO141) can be represented using a coefficient (GSO142), the name of the first argument (GSO143), the first argument coefficient (GSO144), the name of the second argument (GSO145), and the second argument coefficient (GSO146).

The evaluation function for the bread (GSO141A) is 0.42* the sales for “men in their 20s” “between 8 and 9o'clock” +0,2 * the sales for “men in their 40s” “at noon” +0.32. Similarly, with another record such as bread (GSO141E), another evaluation function for the same item may be generated. Although the number of the descriptive indices forming each evaluation function is two in FIG. 8, more descriptive indices from the third argument may be used. Moreover, information other than the above may be contained if it is necessary for the evaluation function.

FIG. 9 shows the object customer extraction table (GSO15) storing the contents of the offer obtained by the process performed for the evaluation function table

(GSO14) in FIG. 8 by the offer extraction unit (GSO4). The object customer extraction table (GSO15) is contained in the database (GSO1) and is a table storing which customer an offer is sent to.

The offer extraction unit (GSO4) assigns the sales (each argument) corresponding to each descriptive index of the evaluation function table (GSO14) by referring to the macro data table. (GSO12), thereby being able to obtain the effect (GSO153) of each evaluation function. The object customer table extraction table (GSO15) is a table in which data is sorted in the order from the highest effect (GSO151) and is provided with a ranking (GSO152). In this table, the data is stored for every item (GSO151). In the example of FIG. 9, for example, the ranking of the bread (GSO151A) is the highest (i.e., the effect is the largest Therefore, when this data is referred to, “men in their 20s” “between 8 and 9 o'clock” is obtained as the candidate 1 (GSO154) and “men in their 4053” “at noon” is automatically extracted as the candidate 2 (GSO155). The business application (GSA) distributes coupons to the customers (CS) satisfying those candidates in response to the judgement of the executive (US). Although the number of the candidates in FIG. 9 is one or two, more candidates from the candidate 3 can be used. FIG. 9 shows a table storing the contents of the offer, and can contain information other than the above if the information is necessary for the offer.

In this manner, the use of the evaluation function table (GSO14) and the object customer extraction table (GSO15) enables automatic extraction of the customers as the objects in the form of a combination of a plurality of candidates. This is more suitable for the real business.

### Second Embodiment

Another exemplary application run in the information processing system of the present invention is described.

The first embodiment describes the contents related to recommendation of an item using the learning and decision system (GSO), while a second embodiment describes the contents related to project management using the learning and decision system (GS0). The system structure. is the same as that in FIG. 1, but is different in the following points.

First, data used for analysis is not the POS data (GCS11), but is business data (not shown). The business data is employee information, attendance information, or the like. The performance information (GSC12) contains matter information (which indicates that an order from a phone company has been successfully received in ten months, for example, and which can be quantitatively evaluated in terms of money indirectly). Second, the business application (GSA) transmits management advice instead of transmitting a recommendation.

Except for the above, the second embodiment can be achieved by the same system structure in that of FIG. 1. However, since it is important how to generate an index in the learning and decision system (GSO), the description is made to the micro data table (GSO11) and the macro data table (GSO12) in the second embodiment.

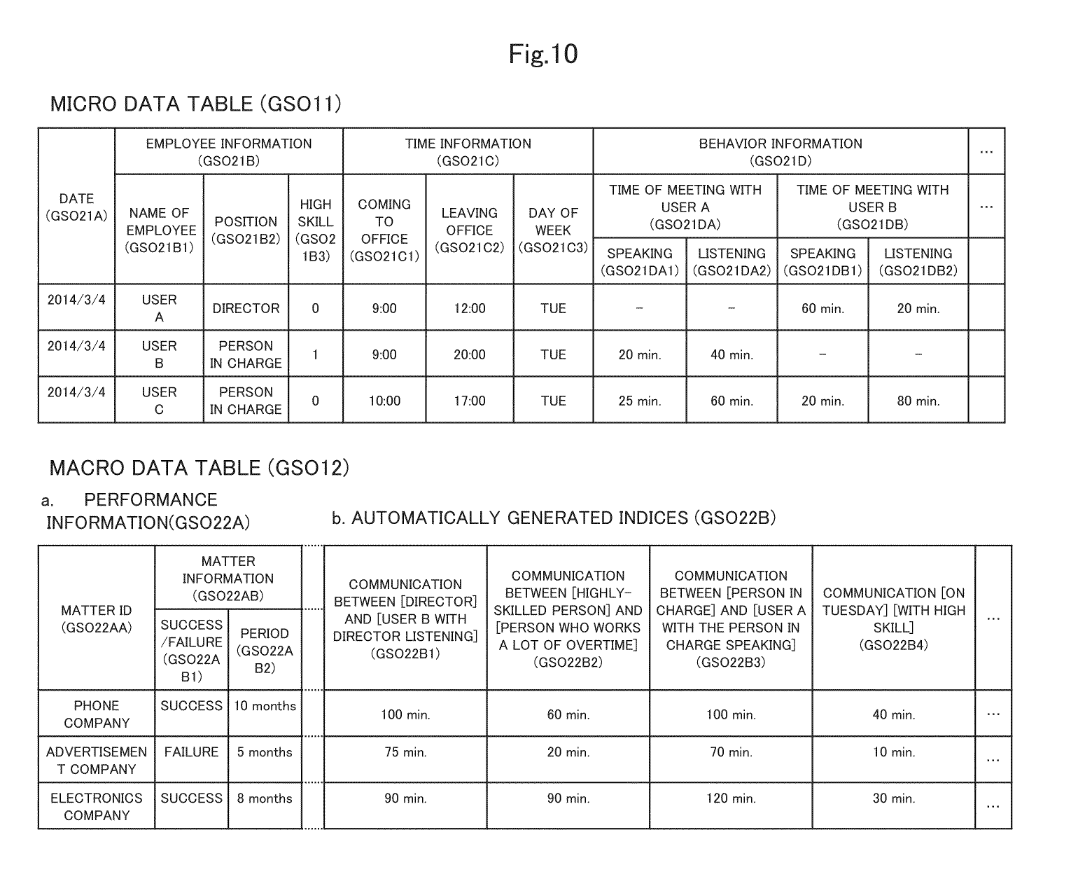

The upper portion of FIG. 10 shows the micro data table (GSO11) stored in the database (GSOI) for being used by the learning and decision system (GSO), based on the business data stored in the backbone database (GSC1). The storage unit of data in the micro data table (GSO11) is desirably the smallest possible granularity. In FIG. 10, data is stored on for each date.

Since data in the micro data table (GSO11) is used for automatic generation of descriptive indices later, the data is desirably data which can be categorized. Moreover, data that is not used by the management system. (GSC2) such as sensor data may be registered in the micro data table (GSO11).

In a case where the granularities of data to be assigned are different, preprocessing may be performed to make the granularities the same. Moreover, in a case where data cannot be classified into the categories, the data may be subjected to preprocessing so that the data is converted into a format in which the data can be classified into the categories.

A date (GSO21A) indicates the date of working day. Since a code is provided for each employee in FIG. 10, the date (GSO21A) can appear a plurality of times. Employee information (GSO21B) is information indicating the attribute of the employee. An employee ID (GSO21B1) indicates the employee number, a position (GSO21B2) indicates the job title of the employee, and a high skill (GSO21B3) indicates a higoh skill level. Time information (GSO21C) is information indicating the contents related to attendance management of the employee and time. Coming to office (GSO21C1) indicates a time of coming to the office, leaving office (GSO21C2) indicates the time of leaving the office, and day of week (GSO21C3) indicates the day of week of the date (GSO21A).

Behavior information (GSO21D) shows the behavior between employees and is obtained for every employee. Meeting time with user A (GSO21DA) shows the behavior involved in the meeting with a user A, in which speaking. (GSO21DA1) indicates the time during which the user A is speaking and listening (GSO21DA2) is the time during which the user A is listening to another person speaking.

In a case where there is data effective for analysis in the learning and decision system (GSO) other than the above, the data other than the above can be added.

The lower portion of FIG. 10 shows the macro data table (GSO12) stored in the database (GSO1) for being used by the learning and decision system (GSO), based on the business data stored in the backbone database (GSC1). The macro data table. (GSO12) is formed with granularity corresponding to the condition of the measure, and is stored on the matter-by-matter basis in FIG. 10. Moreover, since the measure is carried out for every matter, the data is stored on the team-by-team basis in FIG. 10.

Performance information (GSO22A) is converted from the micro data table (GSO11) to have required granularity, and contains the following information. A matter ID (GSO227\A) is information indicating the number unique to the matter. Matter information (GSO22AB) is information on the matter. Success/failure (GSO22AB1) shows the result of the matter, and a period (GSO22AB2) shows the period during which the matter is performed. For example, in FIG. 10, for a matter of which the matter ID (GSO22AA) is a phone company, the success/failure (GSO22AB1) shows success and the period (GSO22AB2) shows 10 months. The performance information. (GSO12A) may be used after being converted from the micro data table (GSO11) to have required granularity.

In automatically generated indices (GSO22B), descriptive indices automatically generated by the index generation unit (GSO2) using the micro data table (GSO11) as its input are stored. The index generation unit (GSO2) uses the micro data table (GSO11) as its input, generates indices by combining categories, and stores the result in the automatically generated indices (GSO22B). The granularity and unit of the automatically generated indices (GSO22B) match those of the performance information (GSO22A).

Examples of the descriptive indices that have been generated by the index generation unit (GSO2) and stored in the automatically generated indices (GSO22B) are communication between [Director] and [User B with Director listening] (GSO22B1), communication between [High-skilled person] and [Person who works a lot of overtime] (GSO22B2), communication between [Person in charge] and [User A with Person in charge speaking] (GSO22B3), and communication with [High skill] [On Tuesday] (0S022B4). In this description, one condition is represented with “[]” (square brackets). The number of conditions may be one or more than one.

In each column, the times of communication under the corresponding condition are stored, and therefore 100 minutes for communication between [Director] and [User B with Director listening] (GSO22B1), 60 minutes For communication between. [Highly-skilled person] and [Person. who works a lot of overtime] (GSO22B2), 100 minutes for communication between [Person in charge] and [User A with Person in charge speaking] (GS022B3), and 40 minutes for communication [On Tuesday] with [High skill] (GS022B4) are stored. Other than those, descriptive indices generated by the index generation unit (GSO2) can be added no the automatically generated indices (GSO22B).

For this macro data table (GS012), the learning engine (GSO3) and the offer extraction unit (GSO4) perform processes similar to those in the first embodiment, thereby the object of the measure can be automatically extracted in form of a behavior of a project member leading to success of a matter.

Finally, control of the behavior of the project member leading to success of the matter is developed by the business application (GSA) to the customer (CS).

As described above, by using the information processing system according to the present invention, it is possible to automatically generate descriptive indices, obtain an evaluation function from a combination of a target index and the descriptive index, and provide the result to the customer via the business application.

In this manner, by using an analysis system according to the present invention, it is possible to discover a measure for achieving an object, which is out of people's anticipation, and to automatically control it through the business application.

### Third Embodiment

Another exemplary application run in the information processing system of the present invention is described.

The first embodiment describes the contents related to item recommendation using the learning and decision system (GSO), while a third embodiment describes the contents related to traveling of a cart in logistics, using the learning and decision system (GSO). The system structure is the same as that in FIG. 1, but is different. in the following points.

First, data used for analysis is not the POS data (GCS11), but business data (not shown). The business data is item information, warehouse information, or the like. Performance information (GSC12) can contain information that can be quantitatively evaluated in terms of money, such as the productivity at the site and the number of records of traveling of a cart (this information may be sales information of a warehouse as in the first embodiment). In addition, the business application (GSA) transmits management advice instead of transmitting a recommendation.

Except for the above, the third embodiment can be achieved by the same system structure as that in FIG. 1. However, since it is important how to generate an index in the learning and decision system (GSO), the description is made to the micro data table (GSO11) and the macro data table (GSO12) in the third embodiment.

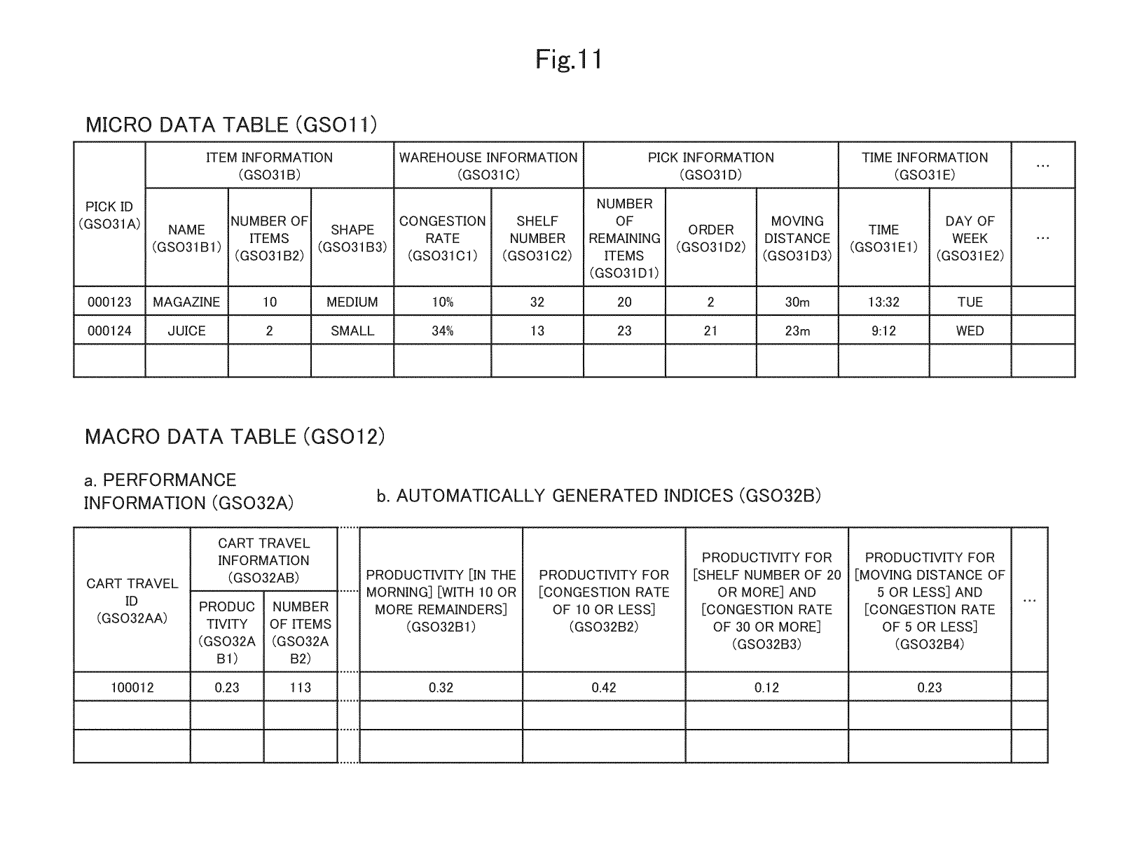

The micro data table (GSO11) used in the third embodiment is shown in FIG. 11. The object of the use is the same as that in the first embodiment.

The upper portion of FIG. 11 shows the micro data table (GSO11) stored in the database (GSO1) for being used in the learning and decision system (GSO), based on the business data stored in the backbone database (GSC1). The storage unit of data in the micro data table (GSO11) is desirably she smallest possible granularity, and the data is stored for every pick ID in FIG. 11. The pick IDs are the numbers on the item-by-item basis and are used when the items are picked.

The data of the micro data table (GSO11) is desirably data that can be categorized because the data is to be used for automatic generation of descriptive indices later. Moreover, data not used in the management system (GSC2) such as sensor data may be registered in the micro data table (GSO11).

Furthermore, in a case where the granularities of the data to be assigned are different, the granularities are made the same by preprocessing. In addition, in a case where the data cannot be categorized, the data may be preprocessed to be converted to have a format in which the data can be categorized.

The pick ID (GSO31A) is the number on the item-by-item basis and is used when the item is picked. Item information (GSO31B) is information indicating the attribute of the item. A name (GSO31B1) indicates the name of the item, number of items (GSO31B2) indicates the number of items to be picked, and a shape (GSO31B3) indicates the size of the item.

Warehouse information (GSO31C) is information indicating the attribute of the warehouse. A congestion rate (GSO31C1) indicates the degree of congestion in the warehouse. A shelf number (GSO31C2) indicates the number of the shelf on which the item is placed.

Pick information (GSO31D) is information related to picking. The number of remainders (GS031D1) indicates the number of remaining items when a cart travels around once.

The order (GSO31D2) indicates the order in which the cart visited during one travel. A moving distance (GSO31D3) indicates a moving distance from the previous shelf at which picking has been performed.

Time information (GSO31E) is information related to time. Time (GSO31F1) indicates the time of picking. Day of week. (GSO31E2) indicates the day of a week of picking.

In a case where there is data effective for analysis in the learning and decision system (GPO) other than the above, the data other than the above can be added.

The lower portion of FIG. 11 shows the macro data table (GSO12) stored in the database (GSOI) for being used in the learning and decision system (GPO), based on the business data stored in the backbone database (GSC1). The macro data table (GSO12) is formed to have granularity corresponding to the condition of the measure and the data is stored for every travel of a cart in FIG. 11.

In performance information (GSO32A), a cart travel ID (GSO32AA) indicates the number of a travel of the cart, and cart travel information (GSO32AB) is information related to the travel of the cart. Productivity (GSO32AB1) indicates the productivity of picking which is defined as the number of pickings per unit time, for example. Number of items (GSO32AB2) indicates the number of picked items during the travel of the cart. For example, the cart travel ID (GSO32AA) indicates 100012, the productivity (GSO32AB1) indicates 0.23, and the number of items (GSO32AB2) indicates 113 in FIG. 11. The performance information (GSO32A) may be converted from the micro data table. (GSO11) to have required granularity and to be used.

In automatically generated indices (GS012B), descriptive indices automatically generated by the index generation unit (GSO2) using the micro data table (GSO11) as its input are stored. The index generation unit (GSO2) uses the micro data table (GSO11) as its input, generates indices by combining the categories, and stores the result in the automatically generated indices (GSO32B). The granularity and unit of the automatically generated indices (CSO32B) are coincident with those of the performance information (GSO32A).

Examples of the descriptive indices generated by the index generation unit (GSO2) and stored in de automatically generated indices (GSO3213) are productivity [in the morning] [with 10 or more remainders] (GSO32B1), productivity for [congestion rate of 10 or less] (GSO32B2), productivity for [shelf number of 20 or more]and [congestion rate of 30 or more] (GSO32B3), and productivity with [moving distance of 5 or less] and [congestion rate of 5 or less (GSO32B4). One condition is represented here with “[]” (square brackets). The number of conditions may be one or more than one.

In each column, the productivities under the corresponding condition are stored, and therefore 0.32 for the productivity [in the morning] [with 10 or more remainders] (GSO32B1), 0.42 for the productivity [for congestion rate of 10 or less] (GSO32B2), 0.12 for the productivity for [shelf number of 20 or more] with [congestion rate of 30 or more] (GSO32B3), and 0.23 for the productivity with [moving distance of 5 or less] and [congestion rate of 5 or less] (GSO32B4) are stored. Other than those, data output by the index generation unit (GSO2) can be added to the automatically generated indices (GSO32B).

For this macro data table (GSO12), the learning engine (GSO3) and the offer extraction unit (GSO4) perform processes similar to those in the first embodiment, thereby the object of the measure can be automatically extracted in form of control of traveling of a cart with high productivity.

As described above, by using the information processing system according to the present invention, it is possible to automatically generate descriptive indices, obtain an evaluation function from a combination of a target index and the descriptive index, and provide the result to the customer via the business application.

In this manner, by using an analysis system. according to the present invention, it is possible to discover a measure for achieving an object, which is out of people's anticipation, and to automatically control it through business application.

### LIST OF REFERENCE SIGNS

US: Executive, CL: Client, CL1: Measure information, CS: Customer, CO: Offer coupon, NW: Network, GS: Business server, GSC: Backbone system, GSC1: Backbone database, GSC11: POS data, GSC12: Performance information, GSC2: Management system, GSC3: Input/output unit, GSO: Learning and decision system, GSO1: Database, GSO2: Index generation unit, GS03: Learning engine, GSO4: Offer extraction unit, GSO5: input/output unit, GSA: Business application, ZOO: Measure decision, Z01: Index generation, Z02: Input of target index, Z03: Correlation analysis, Z04: Output of evaluation function, Z05: Extraction of object customer, Z06: Recommendation transmission, USZ1: Measure transmission, USZ2: Target index transmission, USZ3: Result confirmation, USZ4: Start of recommendation, GSCZ1 to GSCZ2: Data transmission, GSOZ1: Receipt of data, GSOZ2: Index registration, GSZ1: Receipt of recommendation, Z10: Input data, Z11: Output data, GSO11: Micro data table, GSO11A: Receipt ID, GSO11B: Sales information, GSO11B1: Item, GSO11B2: Unit price, GSO11B3: Number of items, GSO11C: Shop information, GSO11C1: ID, GSO11C2: Area, GSO11D: Customer information, GSO11D1: ID, GSO11D2: Age, GSO11D3: Gender, GSO11D4: Area, GSO11E: Purchase information, GSO11E1: Time, GSO11E2: Day of the week, GSO12: Macro data table, GSO12A: Performance information, GSO12AA: Shop information ID, GSO12AB Sales information, GSO12AB1: Item, GSO12AB2: Sales, GSO12AB3: Period, GSO12B: Automatically generated indices, GSO12B1 to GS12B4: Descriptive indices, GSO13: Correlation table, SO131: Item, GSO131A to GSO131B: Exemplary items, GSO132 to GSO135: Descriptive indices, GSO14: Evaluation function table, GSO141: Item, GSO141A to GSO141C: Exemplary items, GSO142 to GSO146: Coefficients or arguments, GSO15: Object customer extraction table, GSO151: Item, GSO151A to GSO151C: Exemplary items, GS0152: Ranking, GSO153: Effect, GSO154 to GSO155: Candidates, GSO21A: Date, GSO21B:

Employee information, GSO21B1: Name of employee, GSO21B2: Position, GSO21B3: High skill, GSO21C: Time information, GSO21C1: Coming to office, GSO21C2: Leaving office, GSO22C3: Day of week, GSO21D: Behavior information, GSO21DA: Time of meeting with user A, GSO21DA1: Speaking, GSO21DA2: Listening, GSO21DB: Time of meeting with user B, GSO21DB1: Speaking, GSO21DB2: Listening, GSO22A: Performance information, GSO22AA: Matter ID, GSO22AB: Matter information, GSO22AB1: Success/failure, GSO22AB2: Period, GSO22B: Automatically generated indices, GSO22B1 to GSO22B4: Descriptive indices, GSO31A: Pick ID, GS031B: Item information, GSO31B1: Name, GSO312: Number of items, GSO31B3: Shape, CSO31C: Warehouse information, GS031C1: Congestion rate, GSO31C2: Shelf number, GSO31D: Pick. information, GSO31D1: Number of remainders, GSO31D2: Order,

GSO31D3: Moving distance, GSO31E: Time information, GSO31E1: Time, GSO31E2: Day of week, GSO32A: Performance information, GSO32AA: Cart travel ID), GSO32AB: Cart travel information, GSO32AB1: Productivity, GSO32AB2: Number of items, GSO32B1 to GSO32B4: Descriptive indices.

1. An information processing system for extracting an object for which a measure is to be taken, comprising:
a reception unit configured to receive first data related to business of an enterprise and second data that is related to the business of the enterprise and has granularity equal to or finer than the granularity of the first data;
an index generation unit configured to generate, from the first data, a plurality of descriptive indices matching the granularity of the second data; and
an extraction unit configured to extract the object for which the measure is to be taken from the plurality of descriptive indices.

2. The information processing system according to claim 1,
wherein the reception unit further receives third data indicating a condition of the measure, and
each of the descriptive indices is a candidate of the object corresponding to the condition of the measure.

3. The information processing system according to claim 2,
wherein the second data is data having a format showing a correspondence between a target index that is a variable to be changed by the measure and the condition of the measure, or is converted into the format showing the correspondence by the index generation unit.

4. The information processing system according to claim 2,
wherein the first data is data having a format in which the first data is classified into a plurality of categories each of which forms a portion or an entire portion of the candidate, or is converted into the format in which the first data is classified into the categories, by the index generation unit.

5. The information processing system according to claim 1,
wherein the extraction unit obtains correlation between each of the plurality of descriptive indices and a target index that is a variable to be changed by the measure, to extract candidates of the object.

6. The information processing system according to claim 5,
wherein the target index is an index capable of being quantified in terms of money.

7. The information processing system according to claim 5,
wherein the extraction unit further generates an evaluation function including the plurality of descriptive indices, and obtains priorities and effects of the candidates based on the evaluation function to extract the candidates.

8. The information processing system according to claim 1,
wherein the first data is POS data, and the second data is data containing sales information of every shop.

9. The information processing system according to claim 1,
wherein the first data is data containing employee information or attendance information, and the second data is data containing success/failure information of a matter.

10. The information processing system according to claim 1,
wherein the first data is data containing item information or warehouse information, and the second data is data containing business productivity.

11. An information processing method for extracting an object for which a measure is to be taken, comprising:
a first step of receiving first data related to business of an enterprise and second data that is related to the business of toe enterprise and has granularity equal to or finer than the granularity of the first data;
a second step of generating, from the first data, a plurality of descriptive indices matching the granularity of the second data; and
a third step of extracting the object for which the measure is to be taken from the plurality of descriptive indices.
